(19) United States
(12) Patent Application Publication
(10) Pub. No.: US 2017/0262537 A1
(43) Pub. Date: Sep. 14, 2017

(54) AUDIO SCRIPTS FOR VARIOUS CONTENT

(71) Applicant: Amazon Technologies, Inc., Seattle, WA (US)

(72) Inventors: Samuel David Harrison, Lake Forest Park, WA (US); Mohamed Mostafa Ibrahim Elshenawy, Bellevue, WA (US); Joseph Bradford Saunders, Seattle, WA (US); Benjamin Schwartz, Seattle, WA (US)

(21) Appl. No.: 15/069,618

(22) Filed: Mar. 14, 2016

(51) Int. Cl. G06F 17/30; G10L 21/055

(52) U.S. Cl. CPC G06F 17/30746; G10L 21/055; G10L 2015/223

(57) ABSTRACT

Disclosed are various embodiments for initiating playback of audio scripts that correspond to content such as books or songs. Verbal content can be captured via a microphone. The text of the verbal content can be assessed to determine whether an audio script specifies a sound effect that should be played at particular cue words within the content. The verbal content is assessed to determine whether a user reading aloud or singing a song has reached a cue word. When a cue word is reached, the sound effect can be played.

### BACKGROUND

Content such as books or songs can be enhanced with accompanying content. For example, a story read aloud can be a more engaging experience when accompanied by an audio soundtrack that includes dramatic, comedic, environmental, musical, or other sound effects. However, obtaining and playing such accompanying content can be difficult and cumbersome.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example scenario of a verbal content and a portion of an audio script that is played in accordance with various embodiments of the present disclosure.

FIG. 2 is a schematic block diagram of a networked environment according to various embodiments of the present disclosure.

FIG. 3 is a flowchart illustrating one example of functionality implemented as portions of query response service executed in a computing environment in the networked environment of FIG. 2 according to various embodiments of the present disclosure.

FIG. 4 is a flowchart illustrating one example of functionality implemented as portions of a content information application executed in a voice interface device in the networked environment of FIG. 2 according to various embodiments of the present disclosure.

FIG. 5 is a schematic block diagram that provides one example illustration of a computing environment employed in the networked environment of FIG. 2 according to various embodiments of the present disclosure.

### DETAILED DESCRIPTION

The present application relates to processing verbal content detected via a microphone and identifying an audio script that can specify sound effects that can be played along or in time with the verbal content. For example, when a user is reading a book, an audio script can include or specify sound effects or background music selected to accompany the user's reading experience. When a user is singing a song acapella, an audio script can be music that is associated with the melody and/or lyrics of the song.

Embodiments of the present disclosure can allow a user to hail or retrieve an audio script by way of a verbal command. In some examples, a device equipped with a microphone can facilitate detection of a book or a song that is being verbalized by a user and initiate playback of an appropriate audio script that facilitates the playback of sound effects at the appropriate time to enhance a user experience. In some embodiments, upon detecting that a particular story or song is being verbalized, the system can query the user to determine if the user would like for the system to accompany the story or song with associated sound effects.

With these embodiments, users can issue a verbal command, such as, “play a soundtrack for” a book or a song, where the user verbalizes the book title or a song title, and then an audio script is played. Additionally, playback of the audio script can be synchronized with the user's verbalizing of the book text or song lyrics. Synchronization can be accomplished through an audio script defining triggering events, such as cue words, word groupings, or phrases for various sound effects. Triggering events can also define when certain sound effects should be terminated.

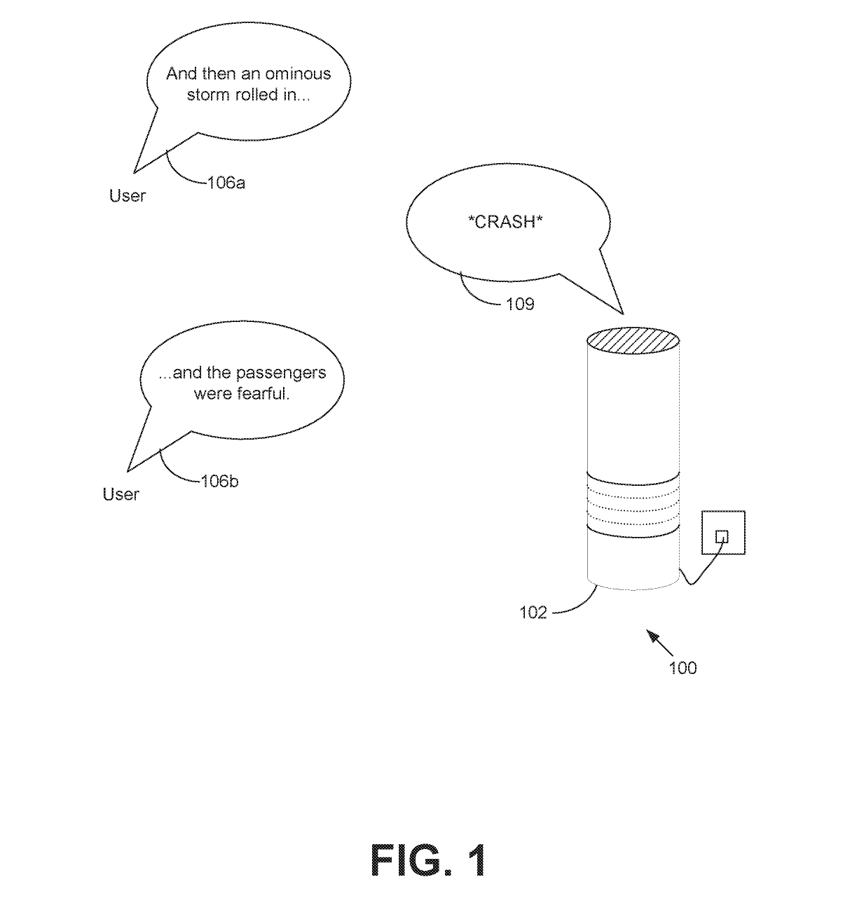

Turning now to FIG. 1, shown is an example scenario 100 in accordance with various embodiments. In the example scenario 100, a user is reading the text of a book in the presence a voice interface device 102. The voice interface device 102 can be equipped with one or more microphones so that the user's voice can be captured and analyzed by the voice interface device 102 or computing devices that are in communication with the voice interface device 102. While reading a book, the user verbalizes a particular portion of the book in the form of verbal content 106a: “And then an ominous storm rolled in . . . ”

The voice interface device 102 can detect a triggering event, such as a cue word, or group of words, in the verbal content 106a that are associated with a sound effect 109 or track of an audio script file that corresponds to the book being read by the user. Once the one or more cue words have been verbalized and detected by the voice interface device 102, the voice interface device 102 initiates playback of the sound effect 109. In some cases, a sound effect 109 might include a longer or repeating sound effect or track, such as background music or background noise. Accordingly, such a sound effect can play continuously upon detection of the cue word or phrase until a subsequent termination cue word or phrase is detected. Therefore, upon detection of the termination cue words verbalized by a user as verbal content 106b, the voice interface device 102 can also terminate playback of the sound effect 109 and await verbalization of the next cue words that are defined by the audio script, if there are any. In the following discussion, a general description of the system and its components is provided, followed by a discussion of the operation of the same.

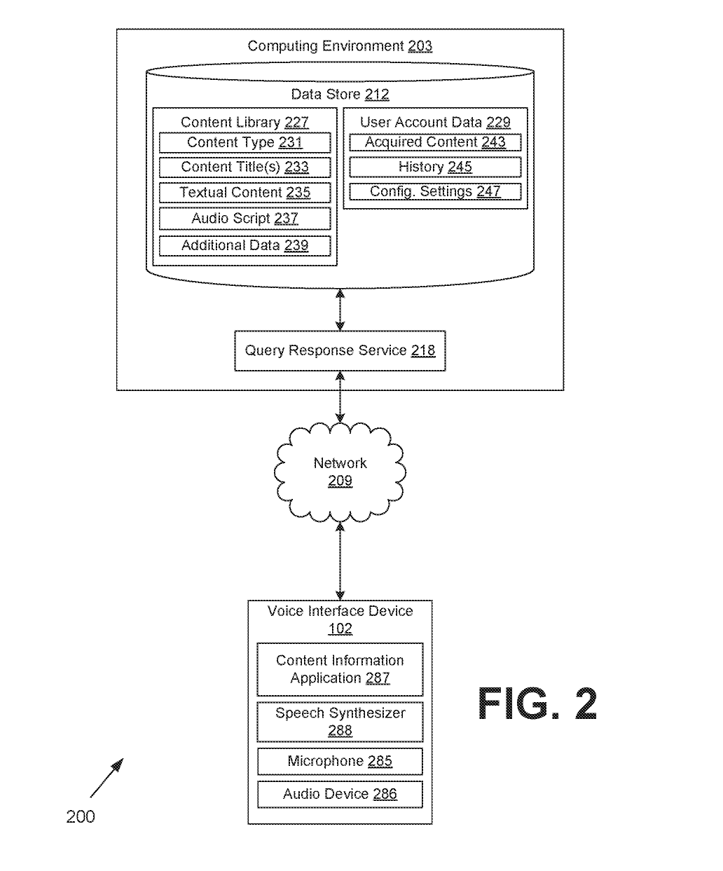

With reference to FIG. 2, shown is a networked environment 200 according to various embodiments. The networked environment 200 includes a voice interface device 102 and a computing environment 203 in data communication via a network 209. The network 209 includes, for example, the Internet, intranets, extranets, wide area networks (WANs), local area networks (LANs), wired networks, wireless networks, or other suitable networks, etc., cable networks, satellite networks, or any combination of two or more such networks.

The computing environment 203 can comprise, for example, a server computer or any other system providing computing capability. Alternatively, the computing environment 203 can employ a plurality of computing devices that can be arranged, for example, in one or more server banks, computer banks, or other arrangements. Such computing devices can be located in a single installation or may be distributed among many different geographical locations. For example, the computing environment 203 can include a plurality of computing devices that together can comprise a hosted computing resource, a grid computing resource, and/or any other distributed computing arrangement. In some cases, the computing environment 203 can correspond to an elastic computing resource where the allotted capacity of processing, network, storage, or other computing-related resources may vary over time.

Various applications and/or other functionality can be executed in the computing environment 203. Also, various data is stored in a data store 212 that is accessible to the computing environment 203. The data store 212 can be representative of a plurality of data stores 212. The data stored in the data store 212, for example, is associated with the operation of the various applications and/or functional entities described below.

The components executed on the computing environment 203, for example, include a query response service 218, and other applications, services, processes, systems, engines, or functionality not discussed in detail herein. The query response service 218 is executed to receive data encoding a verbal content 106 from a voice interface device 102, process the verbal content 106, and then play sound effects in the form of an audio script. As will be discussed, the query response service 218 can return a response for presentation by the voice interface device 102 to obtain additional a user selection of an audio script if more than one audio script is identified that might correspond to the user's initial selection.

The computing environment 203 can also execute one or more applications or services that facilitate purchase, rental, borrowing, download, streaming or other forms of acquiring content such as books or songs. In one example, a user can purchase a book, and the book can be associated with an account of the user in an electronic marketplace. As another example, a user might subscribe to a music service or other membership group that provides the user with access to songs, books, or other forms of content.

The data stored in the data store 212 includes, for example, a content library 227, user account data 229, and potentially other data. The content library 227 can include information about various types of content that have a textual component, such as books, which are associated with text, or songs, with are associated with song lyrics. For a particular piece of content in the content library 227, a content type 231 can identify whether the content is a book, song, or another type of content that has textual component that is also associated with an audio script. A piece of content can also be associated with one or more content titles 233. In some scenarios, a piece of content might be associated with more than one content title 233 to facilitate disambiguation when a user might verbalize a colloquial or commonly known title of a piece of content that might be different from an official or authoritative title of the content. For example, a user might speak “Harry Potter Book 1,” rather than “Harry Potter and the Sorcerer's Stone.” In this scenario, both titles can be associated with a piece of content as a content title 233. As another example, a particular song title might be associated with content from multiple artists. Accordingly, the content title 233 can also include artist information so that the correct content can be identified by the query response service 218.

In some examples, a piece of content can be associated with the textual content 235, which can be the full text of a piece of content. For example, the textual content 235 can include the full text of a book or the full lyrics of a song. It is noted that the full textual content 235 is not required in order to facilitate playback of an audio script according to embodiments of the disclosure.

The audio script 237 defines the sound effects that are associated with a piece of content as well as when a particular sound effect should be played. In other words, the audio script 237 includes the audio content in the form of sound effects, background music, or other audio content. The audio script 237 associates sound effects with a particular portion of a piece of content. In one example, the audio script 237 can define one or more triggering events that are linked to a sound effect. In some examples, the audio script 237 can also divide a piece of content into various scenes, chapters or verses so that the same or similar cue words can be linked to potentially varying sound effects in different portions of the content. In one example, triggering events can be one or more cue words, word phrases or other verbalizations that can be detected. For example, particular cue words in the first chapter of a book can be linked with a first sound effect by the audio script 237, but the same cue words in the second chapter of the book can be linked with a completely different sound effect.

The additional data 239 can identify whether a piece of content is associated with promotional information or rewards. In some scenarios, a reward or promotion can be provided upon initiating playback of an audio script 237 or upon completion of an audio script 237. For example, a retailer or an electronic marketplace can offer an incentive for a user to initiate or complete playback of a particular audio script 237. Such a reward can take the form of a gift card, promotional credit, a free or discounted book or song, or other reward that be associated with a particular user account. The reward or incentive, in one example, can correspond to any item offered for purchase, download, rental, or other form of consumption.

As another example of additional data 239, a particular brand of potato chips may be mentioned in a book or song. The additional data 239 may be used to promote products that are related to or mentioned within content. These promotions can be provide to a user in the form of ad placements when the user is browsing a web site, using an app on a device, or verbalized through the voice interface device 102.

The user account data 229 includes various data about users of the computing environment 203. The user account data 229 can include acquired content 243, history 245, configuration settings 247, and/or other data. The acquired content 243 describes content in the content library 227 to which a user has access. For example, a user may have borrowed, rented or purchased a particular song or book that is associated with an audio script 237. Accordingly, the acquired content 243 can identify audio scripts 237 that a user is entitled to access via the voice interface device 102. In some cases, the acquired content 243 can identify books or songs to which a user is entitled to access, and a lookup table can cross-reference the books or songs with corresponding audio scripts 237. In one scenario, a user might have a subscription that provides access to all or some of the content in the content library 227. For example, a user might have a subscription or entitlement that allows the user to access a swath of audio scripts 237 from the content library 227. Such a subscription may be limited in some way (e.g., number of titles, number of bytes, quality level, time of day, etc.) or unlimited.

The history 245 can include various data describing behavior of a user. Such data may include a purchase history, a browsing history, transaction history, a consumption history, explicitly configured reading, listening or viewing preferences, and/or other data. As understood herein, a “user” may refer to one or more people capable of using a given user account. For example, a user may include one or more family members, roommates, etc. In various embodiments, the extrinsic data may be presented based at least in part on general history of a user account, history of a user account that is attributable to a specific person, and/or history of one or more related user accounts.

The configuration settings 247 can include various parameters that control the operation of the query response service 218 and the voice interface device 102. For example, the configuration settings 247 can encompass profiles of a user's voice, dialect, accent, or other characteristics of the user's speech or language to aid in recognition of the user's speech. These characteristics can also encompass aspects of the speech of multiple users in a household that may share usage of the voice interface device 102.

The voice interface device 102 is representative of a client device that can be coupled to the network 209 and in communication with the computing environment 203. The voice interface device 102 can include, for example, a processor-based system such as a computer system. Such a computer system may be embodied in the form of a special purpose appliance that is intended to receive verbal commands and play sounds through one or more speakers, a smart television, a desktop computer, a laptop computer, personal digital assistants, cellular telephones, smartphones, set-top boxes, music players, web pads, tablet computer systems, game consoles, electronic book readers, or other devices. The voice interface device 102 can be employed to receive voice commands or verbal content 106 from users and respond through a synthesized speech interface. The voice interface device 102 can also play sound effects, music, or other sounds through one or more speakers. Although described as a single device, in some examples, a first device can receive or capture verbal content 106 from users, and one or more other devices can facilitate playback sound effects or responses generated by a speech synthesizer.

The voice interface device 102 may include one or more microphones 285 and one or more audio devices 286. The microphones 285 may be optimized to pick up verbal commands or verbal content from users who, for example, might be in the same room as the voice interface device 102. In receiving and processing audio from the microphones 285, the voice interface device 102 may be configured to null and ignore audio from other sources, such as music sources, video sources, or other ambient sounds, that are present in the environment in which the voice interface device 102 is installed. Thus, the voice interface device 102 is capable of discerning verbal commands from users even while other ambient noises and sounds are simultaneously picked up by the microphones 285. The audio device 286 is configured to generate audio to be heard by a user. For instance, the audio device 286 may include an integrated speaker, a line-out interface, a headphone or earphone interface, a BLUETOOTH interface, etc.

The speech synthesizer 288 can be executed to generate audio corresponding to synthesized speech for textual inputs. The speech synthesizer 288 can support a variety of voices and languages. The content information application 287 is executed to receive verbal content 106 from users via the microphone 285, present responses via the speech synthesizer 288 and the audio device 286 and perform playback of sound effects that are defined by an audio script 237.

In some embodiments, the voice interface device 102 functions merely to stream audio from the microphone 285 to the query response service 218 and to play audio via the audio device 286 that is received from the query response service 218 that the query response service 218 identifies in an audio script 237. In these embodiments, the speech synthesizer 288 can be executed server side along with the content information application 287 in the computing environment 203 to generate an audio stream. In other implementations, the voice interface device 102 can obtain an audio script 237 from the query response service 218 and execute the speech synthesizer 288 and the content information application 287 locally.

Next, a general description of the operation of the various components of the networked environment 200 is provided. To begin, a content publisher can create an audio script 237 that is associated with a piece of content, such as a book, comic, song, album, or another piece of media. The audio script 237, as noted above, can specify various sound effects that should be played at particular portions during performance of a piece of content. For example, during the reading of a book or the singing of a song, the audio script 237 can specify sound effects, such as effects noises or sounds, background music, accompanying voices, background singing, or other types of sound effects that can be played at specific moments.

The audio script 237 can be created manually or with a content editing tool by a publisher. For a particular sound effect in an audio script 237, one or more cue words or phrases can be defined that are associated with the sound effect. In other words, the audio script 237 can specify that a particular sound effect should be played by the audio device 286 when one or more cue words or phrases are detected by the voice interface device 102 via the microphone 285. The audio script 237 can also specify whether a particular sound effect should be played once, twice, thrice, etc., or looped indefinitely. The audio script 237 can also specify whether a particular sound effect should be terminated upon detection of one or more termination cue words.

In some examples, the audio script 237 can associate sound effects with multiple cue words or phrases so that uniqueness can be guaranteed or so that the odds of uniqueness can be increased. In one scenario, the audio script 237 can associate sound effects with a quantity of cue words necessary to uniquely identify a context within a piece of content. For example, a sound effect can be associated with as many cue words as necessary to uniquely identify a particular line in a book or song from among the remaining text of the work. As another example, a sound effect can be associated with three cue words. In another example, a content information application 287 can be configured to identify the context within a piece of content in other ways, as will be discussed below.

A user can acquire rights to a piece of content, such as a book, song, or other piece of media that can be associated with an audio script 237. The user can initiate playback of the audio script 237 along with the user's performance of the piece of content. In other words, a book can be read aloud or a song can be sung aloud by one or more users such that the voice interface device 102 can capture verbal content associated with the performance of the content. To initiate accompaniment of the audio script 237, the user can speak a wake word or phrase that activates the listening capabilities of the voice interface device 102. In some examples, the user can also launch an application or otherwise activate the listening capabilities of the voice interface device 102 such that the content information application 287 is activated.

Next, the user can speak a command that instructs the content information application 287 to activate an accompaniment mode and retrieve an audio script 237 that corresponds to a particular content title 233. In one example, the command can be “Read along with me for Harry Potter and the Sorcerer's Stone.” As another example, the command can be “Sing along for Starman by David Bowie.” In other words, the command can include an instruction to activate an accompaniment mode and a reference to a content title 233 so that the content information application 287 can determine which audio script 237 is appropriate.

In some embodiments, the content library 227 can contain an audio script 237 that corresponds to any unrecognized content title or a generic audio script 237 that can be associated with content that does not have a specific audio script 237 defined in the content library 227. In this scenario, the audio script 237 can define sound effects that can be played along with any content that is read aloud or performed by the user. When the user activates an accompaniment mode of the content information application 287 through a verbal command, the audio script 237 can specify that once certain cue words are spoken by the user, certain sound effects should be played. In one scenario, the audio script 237 can define multiple or different sound effects for certain cue words or phrases from which the content information application 287 can select or rotate. In this way, a more varied user experience can be provided rather than an experience in which the same sound effects are played every time certain cue words or phrases are played.

In some embodiments, before initiating playback of an audio script 237, the content information application 287 can determine whether the user is entitled to access the audio script 237 based upon the entitlements or a transaction history (e.g., a purchase history) associated with the user account. For example, a certain audio script 237 may only be available to users who have purchased a particular book or song, so the content information application 287 and/or query response service 218 can first verity the user's access rights to an audio script 237 before initiating playback.

In one embodiment, the content information application 287 can identify a word in verbal content 106 that includes an instruction to enter an accompaniment mode. The word can be one of many words that are defined as action words for the mode. Next, the content information application 287 can perform a speech-to-text conversion of the remaining words in the verbal content 106 and provide the converted text to the query response service 218. In some examples, another library, service, or application executed by the voice interface device 102 can convert the verbal content 106 to speech on behalf of the content information application 287. The query response service 218 can then determine whether the text corresponds to a content title 233.

In some alternative embodiments, the content information application 287 can simply provide an audio stream or audio file that includes the verbal content 106, which the query response service 218 can convert to text without assistance from the content information application 287. Additionally, the content information application 287 can query the content library 227 directly and identify an appropriate audio script 237 based upon the verbal content 106.

As noted above, a particular audio script 237 can be associated with multiple content titles 233. In one scenario, the query response service 218 can perform an unassisted disambiguation process in which the query response service 218 determines whether the text received from the content information application 287 corresponds to a piece of content that is associated with multiple content titles 233. The query response service 218 can identify the audio script 237 corresponding to the text in this scenario with the benefit of the content titles 233 stored in the content library 227.

In some scenarios, the query response service 218 may be unable to identify a single content title 233 in the verbal content 106. In this case, the query response service 218 can identify a number of choices from which a user can select. In other words, the query response service 218 can identify candidate content titles 233 that are associated with the highest confidence score as being the content title 233 verbalized by the user in a command to initiate an accompaniment mode. In this scenario, the query response service 218 can provide the candidate choices to the content information application 287, which can solicit the user to select from among the choices. The content information application 287 can present the choices to the user by causing a textual response to be read out to the user via the speech synthesizer 288 and the audio device 286. The content information application 287 can obtain a response from the user in the form of verbal content 106 that identifies one of the choices and then obtain the corresponding audio script 237 from the query response service 218.

In some cases, the query response service 218 or content information application 287 can identify a song lyric or textual content of a book within the verbal content 106. In this scenario, a user may simply begin reading a book or singing a song, and the verbal content 106 captured by the content information application 287 can be analyzed to determine whether it corresponds to textual content 235 of a piece of content. If a particular piece of content can be detected based upon such an analysis, the content information application 287 can immediately begin playback of the appropriate audio script 237.

Upon identifying the audio script 237 corresponding to the text in the verbal content 106, the query response service 218 can transmit all or a portion of the audio script 237 to the content information application 287. In some examples, the query response service 218 can also transmit the textual content 235 of the content to the content information application 287 to assist in determining the context or a location within the content that corresponds to verbal content 106 captured via the microphone 285. In some embodiments, the content information application 287 can activate a book or story mode if the content type 231 corresponds to a book or story. The content information application 287 can also activate a karaoke or song mode if the content type 231 corresponds to a song.

Upon receiving the audio script 237, the content information application 287 can then activate a listening process that determines a context of the content being read aloud or performed by the user. The context of the content can be determined based upon an analysis of verbal content 106 captured via the microphone 286 as well as the textual content 235 and/or textual indicators specified by the audio script 237. In this sense, by determining the context of the content, it is meant that the content information application 287 determines a location within the content that a user is reading aloud, singing, or otherwise performing. In other words, the content information application 287 can determine a chapter, verse, line, or specific word within a book or song that corresponds to the verbal content 106 captured via the microphone 285.

In one example, the content information application 287 can identify words in the verbal content 106 that uniquely identify a particular location within the content. In one embodiment, the content information application 287 can also assume that the content is being read from the beginning when a user commences an accompaniment mode. In another example, a user may verbally indicate a chapter, page number, or verse, or other contextual indicator from where playback should begin. Then, as the user reads or performs the content, the content information application 287 can track the user's position within the content to detect cue words defined by the audio script 237.

As noted above, the audio script 237 can specify sound effects with particular points within the content by specifying cue words that are associated with particular sound effects. For example, when a certain line of a book is reached, the audio script 237 can specify that a particular sound effect should be played. Accordingly, once content information application 287 detects the cue words that are specified by the audio script 237, the content information application 287 can initiate playback of the sound effect.

In one embodiment, the audio script 237 can specify multiple cue words associated with the sound effect such that the cue words uniquely identify a particular portion of the content. By associating multiple cue words with a particular sound effect, the audio script 237 can improve the chances that another portion of the content, when spoken or sung by the user, does not cause a false positive association with a particular sound effect. For example, the audio script 237 can associated at least three cue words with a sound effect in one example.

In an alternative embodiment, content information application 287 can maintain a buffer of verbal content 106 captured since the user initiated the accompaniment mode. In this way, the content information application 287 can, based upon an analysis of the buffer, which can be a running analysis, identify a distinction between different portions of the content. For example, the content information application 287 can distinguish between a first verse in a song and a second verse in a song even if the two verses contain the same chorus or identical textual content because the content information application 287 can follow the process of the user through the content by performing a running analysis of the buffer.

As noted above, certain sound effects, in addition to being associated with one or more cue words at which playback of the sound effect should commence, can also be associated with one or more termination cue words at which playback of the sound effect should terminate. Accordingly, upon detection of the termination cue words associated with a sound effect in the verbal content 106, the content information application 287 can terminate playback of the sound effect. For example, in the case of background music or noise that repeats, the termination cue words can indicate when playback of the repeating sound effect should terminate.

In the context of this disclosure, sound effects can take the form of noises, music, voices, or other effects sounds that can be played back through the audio device 286 by the content information application 287. Sound effects specified by the audio script 237 can also take the form of musical notes, percussion hits, or other musical effects that can be played back by the voice interface device 102 or generated by a musical instrument digital interface (MIDI) or similar interface with which the voice interface device 102 is equipped. Sound effects can also be layered. In this sense, a particular sound effect can be initiated at particular cue words and terminated at termination cue words that occur later in the content. In between these cue words and termination cue words, additional sound effects can also be triggered and terminated as specified by the audio script 237.

The content information application 287 can also detect completion of content corresponding to an audio script 237 by detecting the end of the content or termination keywords within the verbal content 106. In some embodiments, upon completion of a book or a song, the content information application 287 can terminate the listening process that listens for verbal content 106 and initiates playback of sound effects. In some cases, additional data 239 corresponding to a piece of content may indicate that a reward or promotion should be associated with a user account in response to completion of a piece of content. In some cases, the additional data 239 can indicate that a reward or promotion should be rewarded if the user reaches a certain point within the content, such as a particular chapter, verse, or other progress within the content. Accordingly, the content information application 287 can transmit such an indication to the query response service 218, which can update the user account with such a reward or promotion.

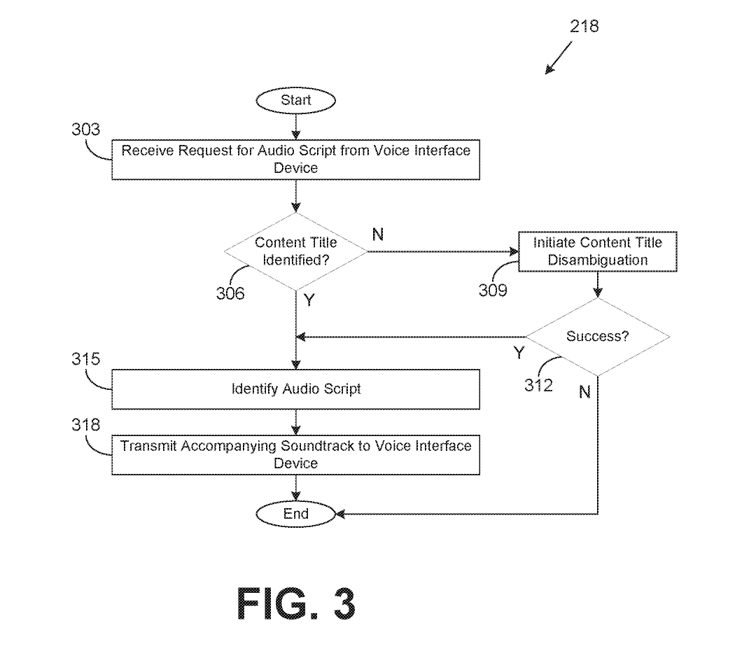

Referring next to FIG. 3, shown is a flowchart that provides one example of the operation of a portion of the query response service 218 according to various embodiments. It is understood that the flowchart of FIG. 3 provides merely an example of the many different types of functional arrangements that may be employed to implement the operation of the portion of the query response service 218 as described herein. As an alternative, the flowchart of FIG. 3 can be viewed as depicting an example of elements of a method implemented in the computing environment 203 according to one or more embodiments. FIG. 3 illustrates an example of how the query response service 218 can receive a request for an audio script 237 and provide an appropriate audio script 237 that the content information application 287 can utilize to identify sound effects for playback to accompany verbal content 106 that is spoken or performed by the user.

Beginning with box 303, the query response service 218 receives a request for an audio script 237 from the content information application 287. The request can include a speech-to-text conversion of verbal content 106 captured by the voice interface device 102. In another embodiment, the request can include verbal content 106 itself, which can be processed by the query response service 218. At box 306, the query response service 218 can determine whether a content title 233 can be identified within the request from the content information application 287.

If a content title 233 cannot be identified within the request, the process proceeds to box 309, and the query response service 218 can initiate disambiguation so that a particular audio script 237 within the content library 227 can be identified. In one example, disambiguation can take the form of the query response service 218 identifying candidate content titles 233 that are associated with multiple pieces of content from the content library 227. The candidate content titles 233 can be identified by calculating a confidence score with multiple content titles 233 and provide the candidate content titles 233 to the content information application 287. For example, the query response service 218 can provide the two or three content titles 233 having the highest confidence score to the content information application 287.

In response to receiving the candidate content titles 233, the content information application 287 can prompt the user to select one of the candidates. If the query response service 218 can successfully perform disambiguation and select a content title, the process can proceed to box 315. If disambiguation is not successful, the process can proceed from box 312 to completion without identifying an audio script 237. In one example, the query response service 218 can return an error to the content information application 287. Otherwise, the process can proceed to box 315.

At box 315, the query response service 218 can identify an audio script 237 associated with the content title 233. The query response service 218 can then transmit the audio script 237 associated with the content title 233 to the content information application 287 at box 318. Thereafter, the process proceeds to completion.

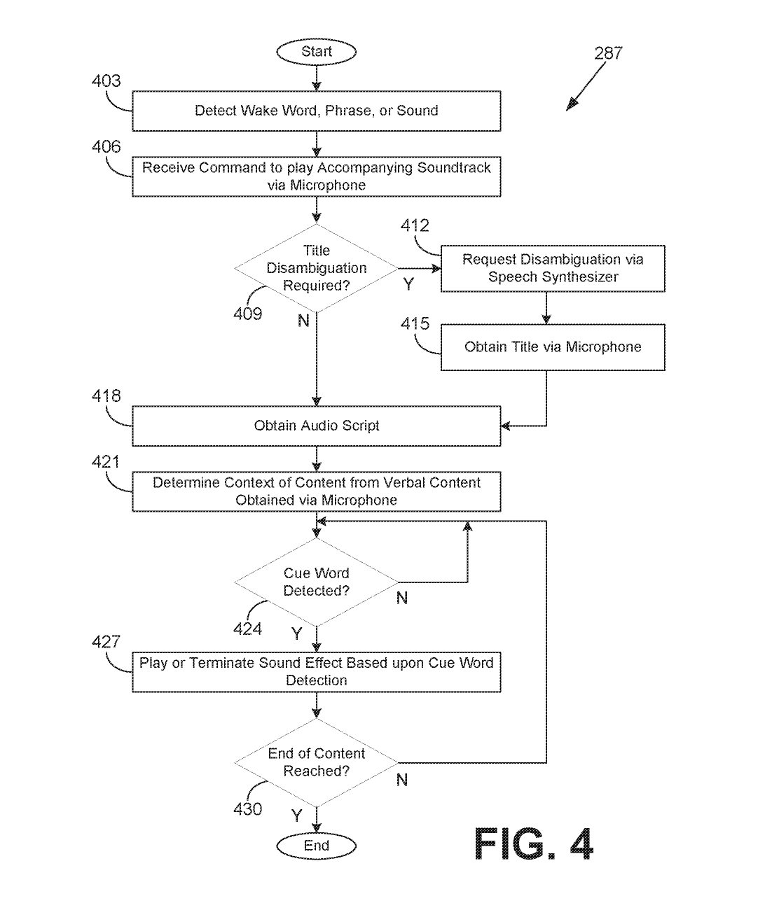

Referring next to FIG. 4, shown is a flowchart that provides one example of the operation of a portion of the content information application 287 according to various embodiments. It is understood that the flowchart of FIG. 4 provides merely an example of the many different types of functional arrangements that may be employed to implement the operation of the portion of the content information application 287 as described herein. As an alternative, the flowchart of FIG. 4 can be viewed as depicting an example of elements of a method implemented in the voice interface device 102 according to one or more embodiments. FIG. 4 illustrates an example of how the content information application 287 can facilitate playback of an audio script 237 along with content that is read aloud or performed by a user can captured via a microphone 285.

At box 403, the content information application 287 detects a wake word, phrase, or sound from a user through a microphone 285. For example, users may say “Wake up!” and/or clap their hands together twice, which would be preconfigured respectively as a wake phrase or sound. In some embodiments, the content information application 287 is always listening and a wake word, phrase, or sound is not required. In various scenarios, the content information application 287 may be activated via a button press on a remote control, or via a user action relative to a graphical user interface of an application of a mobile device.

In box 406, the content information application 287 receives a command to play an audio script 237 via the microphone 285. The command can be obtained by capturing verbal content 106 via the microphone 285, performing natural language processing on the verbal content 106, and extracting a command verbalized by the user to enter an accompaniment mode. The verbal content 106 can also include a content title 233. At box 409, the content information application 287 can determine whether disambiguation of the content title 233 is required. If disambiguation is not necessary, the process can proceed to box 418. In one embodiment, the content information application 287 can transmit a speech-to-text conversion of verbal content 106 captured from a user via the microphone 285 to the query response service 218. The query response service 218 can return an indication of whether disambiguation of the content title 233 is required as well as provide candidate content titles 233 that can be selected by the user. If, at box 409, the content information application 287 determines that disambiguation of the content title 233 is required, then at box 412, the content information application 287 requests the user to select one of the candidate content titles 233 by presenting a follow-up question in order to prompt the user to select one of the candidate content titles 233.

At box 415, the content information application 287 can obtain a selection of the user of one of the candidate content titles 233 via the microphone 285. Then the process can proceed to box 418, where the content information application 287 can obtain the audio script 237 corresponding to the content title 233 from the query response service 218. At box 421, the content information application 287 can initiate a listening process that obtains verbal content 106 from the microphone 285 and determines a corresponding context within a piece of content corresponding to the audio script 237.

At box 424, the content information application 287 can determine whether one or more cue words identified by the audio script 237 are in the verbal content 106. If not, the content information application 287 can continue to listen for verbal content 106 and continue to analyze the verbal content 106 to determine a context within the content corresponding to the audio script 237. If, at box 424, cue words corresponding to a sound effect are identified, the process proceeds to box 427, where the content information application 287 can either play or terminate the sound effect based upon whether the cue words correspond to initiating or terminating playback of the sound effect. At box 430, the content information application 287 can determine whether the end of the content corresponding to the audio script 237 has been reached. In one example, the content information application 287 can identify cue words corresponding to the end of the content, such as the end of a book or song. In another example, the content information application 287 can detect termination keywords that the user can speak, such as a command to cease playback of the audio script 237. If the end of the content has been reached or the accompaniment mode terminated by the user, the process can proceed to completion. If the end of the content has not been reached, the process can return to box 424, where the content information application 287 can listen for cue words and track the context of the content corresponding to the audio script 237.

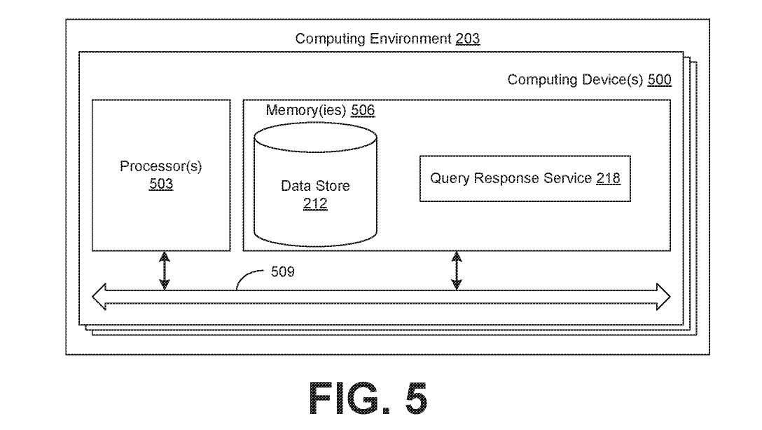

With reference to FIG. 5, shown is a schematic block diagram of the computing environment 203 according to an embodiment of the present disclosure. The computing environment 203 includes one or more computing devices 500. Each computing device 500 includes at least one processor circuit, for example, having a processor 503 and a memory 506, both of which are coupled to a local interface 509. To this end, each computing device 500 may comprise, for example, at least one server computer or like device. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 is the query response service 218 and potentially other applications. Also stored in the memory 506 may be a data store 212 and other data. In addition, an operating system may be stored in the memory 506 and executable by the processor 503.

It is understood that there may be other applications that are stored in the memory 506 and are executable by the processor 503 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

Although the query response service 218, the content information application 287, the speech synthesizer 288, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4 and 5 show the functionality and operation of an implementation of portions of the content information application 287 and the query response service 218. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIGS. 4 and 5 show a specific order of execution, it is understood that the order of execution may differ from that which is depicted. For example, the order of execution of two or more blocks may be scrambled relative to the order shown. Also, two or more blocks shown in succession in FIGS. 4 and 5 may be executed concurrently or with partial concurrence. Further, in some embodiments, one or more of the blocks shown in FIGS. 4 and 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the query response service 218, the content information application 287, and the speech synthesizer 288, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the query response service 218, the content information application 287, and the speech synthesizer 288, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 500, or in multiple computing devices 500 in the same computing environment 203. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A non-transitory computer-readable medium embodying a program executable in at least one computing device, wherein when executed the program causes the at least one computing device to at least:
receive verbal content via a microphone associated with a user account;
identify a command to initiate playback of an audio script in the verbal content;
identify at least two books in a content library corresponding to the verbal content by identifying a plurality of content titles from the content library associated with a highest confidence score, wherein a confidence score ranks the plurality of content titles as being a content title verbalized by the user;
disambiguate the verbal content by selecting a highest ranked one of the at least two books corresponding to the verbal content;
select a particular audio script corresponding to the highest ranked one of the at least two books;
initiate a listening process that detects a portion of the highest ranked one of the at least two books that is currently being read via the microphone;
determine whether the portion of the highest ranked one of the at least two books contains a triggering event associated with initiation of a sound effect;
initiate playback of the sound effect upon detection of the triggering event;
determine whether the portion of the highest ranked one of the at least two books contains a termination triggering event associated with the termination of the sound effect;
terminate playback of the sound effect upon detection of the termination triggering event; and
detect that the content of the highest ranked one of the at least two books has terminated; and
terminate the listening process.

2. The non-transitory computer-readable medium of claim 1, wherein when executed the program further causes the at least one computing device to at least identify a context of the portion of the highest ranked one of the at least two books by detecting a plurality of words via the microphone.

3. The non-transitory computer-readable medium of claim 1, wherein the program detects that the content of the highest ranked one of the at least two books has terminated by detecting at least one triggering event associated with completion of the book.

4. A system, comprising:
at least one computing device; and
at least one application executed in the at least one computing device, wherein when executed the at least one application causes the at least one computing device to at least:
receive a verbal command via a microphone to initiate playback of an audio script;
convert the verbal command to text via a speech-to-text conversion;
identify at least two content titles in a content library corresponding to the text by identifying a plurality of content titles from the content library associated with a highest confidence score, wherein a confidence score ranks the plurality of content titles as being a content title verbalized by a user;
disambiguate the verbal command by selecting a highest ranked one of the at least two content titles corresponding to the text;
select a particular audio script corresponding to the highest ranked one of the at least two content titles;
identify verbal content via the microphone;
identify a context of the verbal content;
determine whether the context of the verbal content is associated with a sound effect by the particular audio script; and
initiate playback of the sound effect in response to determining that the context of the verbal content is associated with the sound effect.

5. The system of claim 4, wherein when executed the at least one application validates whether a user account is entitled to access the particular audio script based upon a determination of whether of a transaction history of the user account contains an item that is associated with the particular audio script.

6. The system of claim 4, wherein when executed the at least one application identifies the context of the verbal content by:
identifying a plurality of words in the verbal content; and
identifying the plurality of words in content associated with a book or a song, wherein the plurality of words uniquely identify a location within the book or the song.

7. The system of claim 4, wherein when executed the at least one application identifies the context of the verbal content by:
maintaining a buffer of a plurality of words in the verbal content; and
identifying a location in a book or a song based upon an analysis of the buffer of the plurality of words.

8. (canceled)

9. The system of claim 4, wherein the at least one application determines whether the context of the verbal content is associated with the sound effect by the particular audio script by detecting a triggering event within the context of the verbal content that is associated with the sound effect.

10. The system of claim 9, wherein when executed the at least one application further causes the at least one computing device to at least:
detect a termination triggering event within the context of the verbal content; and
terminate playback of the sound effect in response to detection of the termination triggering event.

11. (canceled)

12. The system of claim 4, wherein when executed the at least one application further causes the at least one computing device to at least:
detect completion of the verbal content associated with the particular audio script; and
associate a reward with a user account of a user in response to detection of completion of the verbal content associated with the particular audio script.

13. A method, comprising:
receiving, via at least one computing device, a verbal command to accompany verbal content with sound effects specified by an audio script;
converting, via the at least one computing device, the verbal command to text via a speech-to-text conversion;
identifying, via the at least one computing device, at least two content titles in a content library corresponding to the text by identifying a plurality of content titles from the content library associated with a highest confidence score as being a content title verbalized by the user;
disambiguating, via the at least one computing device, the verbal command by selecting a highest ranked one of the at least two content titles corresponding to the text;
selecting, via the at least one computing device, a particular audio script corresponding to the highest ranked one of the at least two content titles;
capturing, via the at least one computing device, the verbal content via a microphone;
determining, via the at least one computing device, whether the verbal content is associated with a sound effect by the particular audio script; and
initiating playback of the sound effect in response to determining that the verbal content is associated with the sound effect.

14. The method of claim 13, further comprising:
identifying, via the at least one computing device, a location within a work based upon an analysis of the verbal content; and
determining, via the at least one computing device, whether the location within the work is associated with the sound effect by the particular audio script.

15. The method of claim 13, wherein the verbal command to accompany verbal content comprises one of a command to accompany a book or a command to accompany a song.

16. The method of claim 13, wherein selecting the particular audio script further comprises:
identifying, via the at least one computing device, at least one of a title of a book or a title of a song corresponding to the text.

17. The method of claim 13, wherein selecting the particular audio script further comprises:
converting, via the at least one computing device, the verbal content to text via a speech-to-text conversion; and
identifying, via the at least one computing device, a song lyric corresponding to a song that corresponds to the text.

18. The method of claim 13, wherein selecting the particular audio script further comprises:
converting, via the at least one computing device, the verbal content to text via a speech-to-text conversion; and
identifying, via the at least one computing device, a location in textual content of a book corresponding to the text.

19. The method of claim 13, further comprising:
maintaining a buffer of the verbal content; and
identifying a location within a work based upon an analysis of the buffer of the verbal content.

20. The method of claim 19, further comprising distinguishing a first portion of the work from a second portion of the work based upon the analysis of the buffer of the verbal content, wherein the first portion of the work and the second portion of the work correspond to identical textual content.
